(19) United States
(12) Patent Application Publication
(10) Pub. No.: US 2026/0135368 A1
(43) Pub. Date: May 14, 2026

(54) CABLE GLAND WITH CABLE GRIPPING FERRULE

(71) Applicant: HELLERMANNTYTON (PTY) LTD, Frankenwald, Johannesburg (ZA)

(72) Inventors: Barend Hercules Philippus Swanepoel, Pretoria (ZA); Peter Don Phillips, Frankenwald, Johannesburg (ZA)

(21) Appl. No.: 19/119,149

(22) PCT Filed: Aug. 31, 2023
(86) PCT No.: PCT/IB2023/058605

§ 371 Date: Apr. 8, 2025

(30) Foreign Application Priority Data
Oct. 31, 2022 (NL) 2033427

(51) Int. Cl. H02G 15/013; H02G 15/007; H02G 15/117

(52) U.S. Cl. CPC H02G 15/013; H02G 15/007; H02G 15/117

(57) ABSTRACT

A cable gland 10 comprises an elongate body 12 and a cable gripping ferrule 14. The body 12 has a first end 13 and a second end 15. The body 12 comprises a formation 20 adjacent an axially extending passage 16 extending between the first end 13 and the second end 15. The passage 16 is configured to receive a cable 18 extending through the body 12. The cable gripping ferrule 14 is locatable in the passage 16. The ferrule 14 defines an eye 24 extending between a cable entry mouth 26 facing the first end 13 and a cable exit mouth 28 facing the second end 15. The ferrule 14 comprises an inner surface 30 adjacent the eye 24, an frusta-conical outer surface 32 and cable gripping formations 34 at each of the mouth 26 and the mouth 28. The surface 32 is configured such that when the surface 32 is urged against the formation 20, the ferrule 14, in constrictive manner, directly grips onto the cable 18 with the formations 34 at both the mouth 26 and the mouth 28.

### INTRODUCTION AND BACKGROUND

This invention relates to a cable gland and more particularly to a cable gland comprising a cable gripping ferrule.

Known cable glands comprise a first gland body, a second gland body and a cable gripping member located between the first and second bodies. When the first and second gland bodies are displaced towards each other, the cable gripping member is deformed by the two bodies to grip onto the cable. Once sufficiently gripped, the cable will not be displaceable relative to the cable gland if a force less than the specified pull-out force is applied to the cable.

The pull-out forces of known cable glands may not be sufficient for at least some applications. Accordingly, there exists a need for a cable gland which can provide improved pull-out forces compared to the cable glands known in the art.

Another disadvantage of known cable glands is that installation of these cable glands on cables is awkward and laborious. This is particularly the case when a cable gland for a steel wire armoured (SWA) cable is installed on such a cable. The installation of a SWA cable gland requires at least the following steps: a) disassembling of the cable gland; b) threading a first gland body part with the cable; c) bending (also known as flaring) steel wire armouring of the cable away from an inner bedding of the cable; d) threading a conical member with the cable and locating the conical member between the inner bedding and the bent (flared) steel wire armouring; e) threading a second gland body part with the cable; and f) assembling the cable gland. During the above installation process, an artisan may easily drop one of the parts of the cable gland, causing undesirable loss of time and/or loss of the dropped part.

U.S. Pat. No. 6,162,995 discloses a connector for an armoured electrical cable. The connector comprises a nut, a body and a dual finger member. The nut, body and dual finger member are all made of conductive material. In use, the dual finger member is located in a bore of the body and when the nut is tightened on the body, fingers of the dual finger member bend to squeeze around a cable to be retained by the connector.

US2016/0134093A1 discloses a device for establishing electrical contact between a shield of an electrical cable and a conductive housing wall through which the cable enters the housing. The device comprises an under-sleeve and a contact sleeve. In use, the shield of the electrical cable is folded back by 180° and placed over the under-sleeve. Thereafter, the contact sleeve is a) slid over the shield which is folded back over the closure cap and the contact sleeve b) crimped to the under-sleeve and c) connected to the housing in an electrically conductive manner.

EP4060838A1 discloses a half screw connection comprising a male part, a securing part and a union nut. The securing part comprises latching hooks at one end of the securing part. In use, the securing part is located between the male part and union nut. When the union nut is screwed onto the male part, the latching hooks reach through an opening of the union nut and rest with a hook-shaped section on an edge around the opening.

### OBJECT OF THE INVENTION

Accordingly, it is an object of the present invention to provide a cable gland with which the applicant believes the aforementioned disadvantages may at least be alleviated or which may provide a useful alternative for the known cable glands.

### SUMMARY OF THE INVENTION

According to the invention there is provided for a cable gland comprising:
an elongate body having a first end and a second end and comprising a sloping formation adjacent an axially extending passage extending between the first end and the second end and configured to receive a cable extending through the body; and
a cable gripping ferrule locatable in the axially extending passage, the cable gripping ferrule defining a first eye extending between a cable entry mouth of the cable gripping ferrule facing the first end of the body and a cable exit mouth of the cable gripping ferrule facing the second end of the body, the cable gripping ferrule comprising an inner surface adjacent the first eye, a frusta-conical outer surface and cable gripping formations at each of the cable entry mouth and cable exit mouth, the frusta-conical outer surface being configured such that when the outer surface is urged against the sloping formation, the cable gripping ferrule, in constrictive manner, directly grips onto the cable with the formations at both the cable entry mouth and the cable exit mouth.

The cable entry mouth may be substantially circular in shape and may have a first diameter d₁, the cable gland may comprise a non-sealing guide ring for receiving and guiding the cable, the guide ring may comprise a body defining a second eye and may have a circular inner wall adjacent the second eye, the circular inner wall may have a second diameter d₂ which is not larger than the first diameter d₁.

The inner wall of the guide ring may extend between a first end of the body and a second end of the body and may comprise at least a first part which is funnel shaped, the funnel shaped first part may extend from a wider end located towards the first end of the body to a narrower end located intermediate the first end of the body and the second end of the body.

The guide ring may form part of an inner ferrule which defines a slit extending from the first end to the second end, the cable gripping ferrule may enclose the inner ferrule between an inner surface of the cable gripping ferrule and the cable.

The slit may be is non-linear.

The inner ferrule may be resiliently deformable.

The guide ring may be located in the body between the first end of the body and the cable entry mouth of the cable gripping ferrule.

The guide ring may comprise at least one radially extending formation.

The cable gripping formations may comprise teeth or serrations.

The cable gripping ferrule may be made of an electrically conductive material.

The cable gripping ferrule may be resiliently constrictable.

The cable gripping ferrule may comprise a body which may define a slit extending between the cable entry mouth and the cable exit mouth.

The outer surface of the cable gripping ferrule may slope from a first end of the body having a first transverse cross-sectional area to a second end of the body having a second transverse cross-sectional area which is larger than the first transverse cross-sectional area.

The cable gland may comprise an annular elastomeric seal locatable in the axially extending passage, the seal may comprise an inner sealing surface and an outer sealing surface, the seal may define a first opening adjacent the inner sealing surface for receiving the cable and at least one further opening between the inner sealing surface and the outer sealing surface.

The cable gland may comprise an annular seal deforming member comprising a body having a first face which, in use, abuts the annular elastomeric seal, a second opposed face and an inner wall between the first face and the second face, the inner wall defining an opening for receiving the cable.

The annular seal deforming member may comprise at least one axially extending link which, in use, extends through the at least one further opening and between the first face of the annular seal deforming member and an abutment surface of the cable gland.

The cable gland may comprise a first body part, comprising the first end, and a second body part, comprising the second end, and which are axially adjacent each other, the first and second body parts comprising respective mutually cooperating formations which, when actuated, cause the first and second body parts to be urged towards each other and to cause the outer surface of the cable gripping ferrule to be urged against the sloping formation.

The first body part may define a first part of the axially extending passage which first part may extend from a first end of the first body part to a second end of the first body part, a first of the mutually cooperating formations may be provided towards the second end of the first body part, and the second body part may comprise first and second concentric tubular parts, the second tubular part may have a larger radius than the first tubular part, the first tubular part defining a second part of the axially extending passage which second part extends from a first end of the first tubular part to a second end of the first tubular part, the first end of the first tubular part providing the abutment surface and the second tubular part comprising a second of said mutually cooperating formations.

The first body part may define at least one slot.

According to another aspect of the invention there is provided for a cable gland comprising:
an elongate body having a first end and a second end, the elongate body defining an axially extending passage extending between the first end and the second end and configured to receive a cable extending through the body, the elongate body comprising electrically insulating first and second body parts axially adjacent each other, the first and second body parts presenting the first end and the second end respectively and comprising respective mutually cooperating formations located towards ends opposed to the first end and second end respectively, the second body part comprising an electrically conductive tubular part providing an abutment surface, the elongate body comprising a sloping formation adjacent the axially extending passage and presenting an inner sealing surface adjacent the axially extending passage;
an electrically conductive cable gripping ferrule locatable in the axially extending passage, the cable gripping ferrule defining a first eye extending between a cable entry mouth of the cable gripping ferrule facing the first end of the body and a cable exit mouth of the cable gripping ferrule facing the second end of the body, the cable gripping ferrule comprising a frusta-conical outer surface and cable gripping formations at each of the cable entry mouth and cable exit mouth; and
a cable gland sealing arrangement locatable in the passage, the cable gland sealing arrangement comprising:
   an annular elastomeric seal comprising an inner sealing surface and an outer sealing surface and defining a first opening adjacent the inner sealing surface for receiving the cable and at least one second opening between the inner sealing surface and the outer sealing surface;
   an electrically conductive annular seal deforming member comprising a body having a first face, a second opposed face, and defining a third opening for receiving the cable and at least one electrically conductive axially extending link which extends through the at least one second opening;
      the cable gland being configured such that when the first and second body parts are actuated:
   the mutually cooperating formations cause the first and second body parts to be urged towards each other;
   the frusta-conical outer surface to be urged against the sloping formation, so that the cable gripping ferrule, in constrictive manner, directly grips onto the cable with the formations at both the cable entry mouth and the cable exit mouth;
   the annular elastomeric seal to deform such that the inner sealing surface is urged radially inwardly in sealing engagement with an inner bedding of the cable and the outer sealing surface is urged radially outwardly to seal against the inner sealing surface of the elongate body; and
   the axially extending link to abut against the abutment surface, such that the cable gripping ferrule, the seal deforming member and the tubular part form an electrically conductive path.

### BRIEF DESCRIPTION OF THE ACCOMPANYING DIAGRAMS

The invention will now further be described, by way of example only, with reference to the accompanying diagrams wherein:

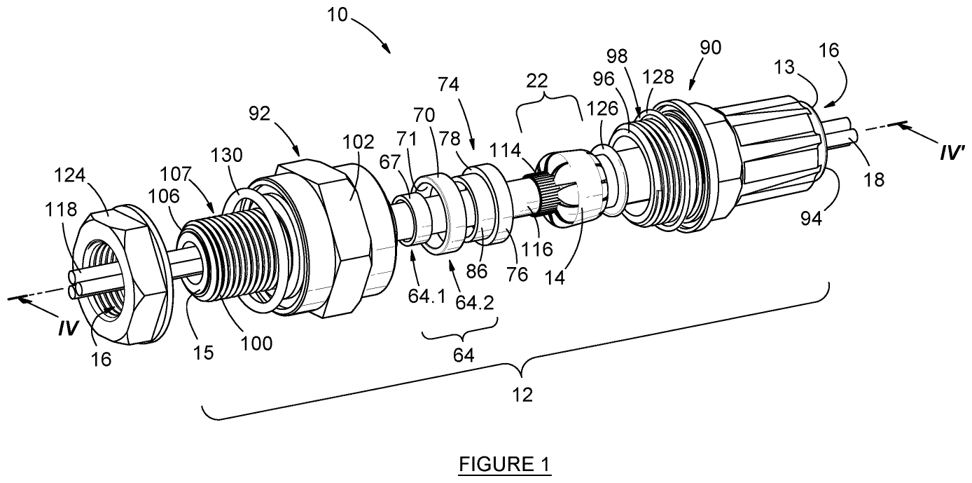

FIG. 1 is a diagrammatic perspective view of a first example embodiment of a cable gland in an exploded form;

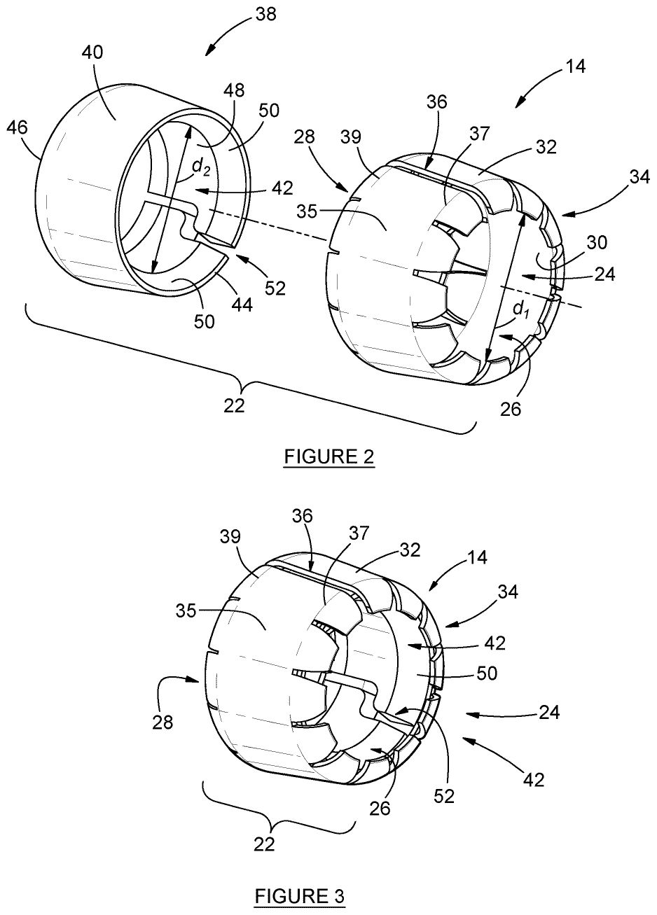

FIG. 2 is a diagrammatic perspective view from a first end of a first cable gripping assembly in exploded form;

FIG. 3 is a diagrammatic perspective view from a second end of the first cable gripping assembly in assembled form;

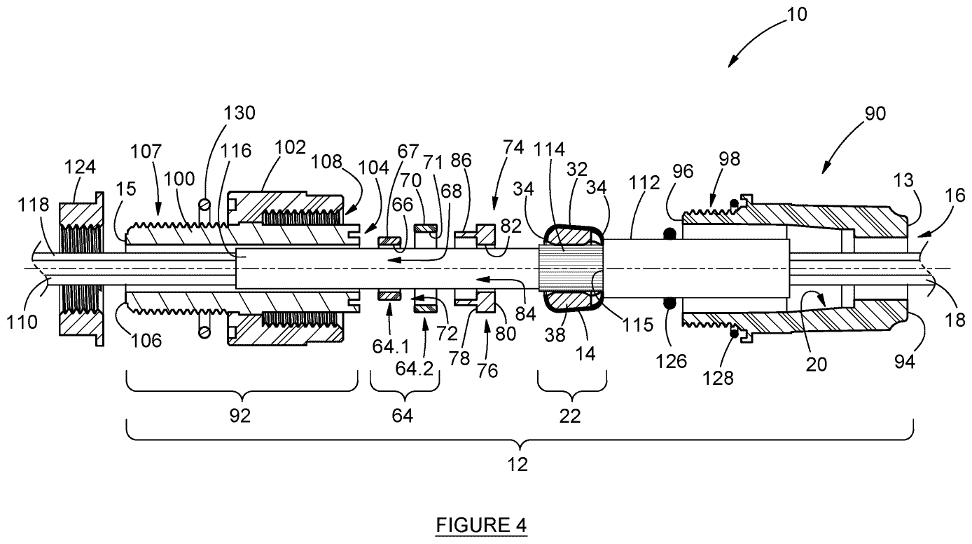

FIG. 4 is a section on line IV in FIG. 1;

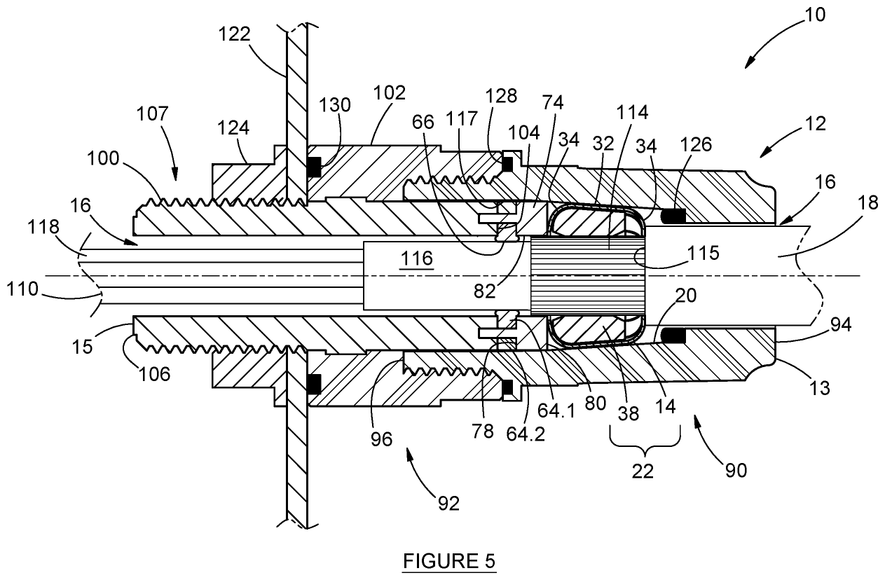

FIG. 5 is an assembled version of FIG. 4;

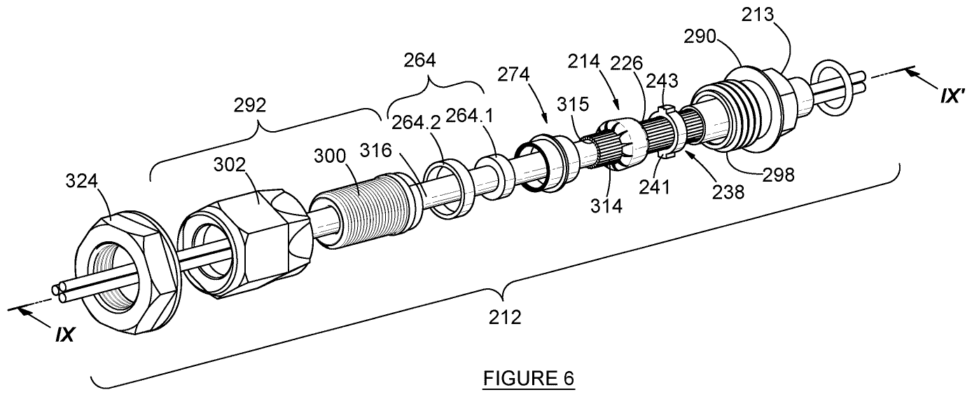

FIG. 6 is a diagrammatic perspective view of a second example embodiment of a cable gland in an exploded form;

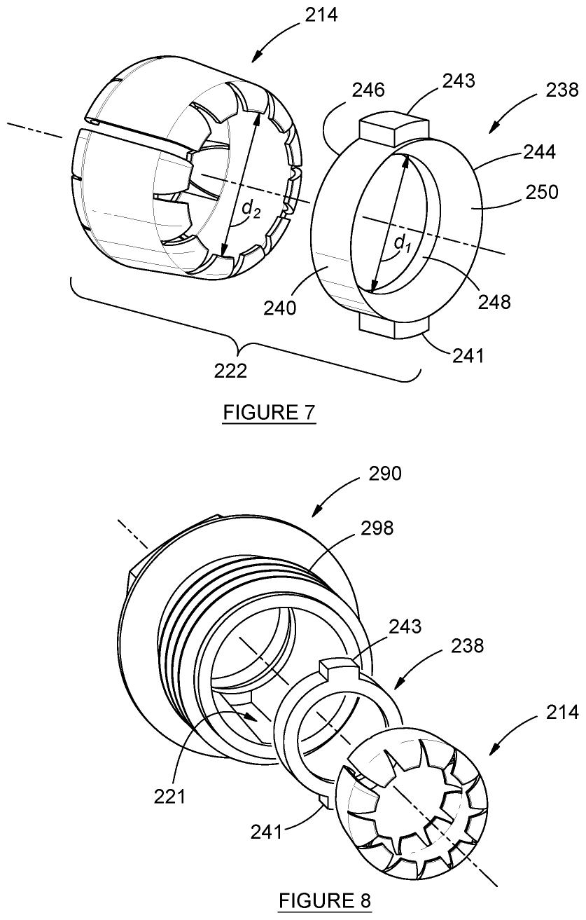

FIG. 7 is a diagrammatic perspective view from a first end of a second cable gripping assembly in exploded form;

FIG. 8 is a diagrammatic perspective view from a second end of the second cable gripping assembly and a first body part in exploded form;

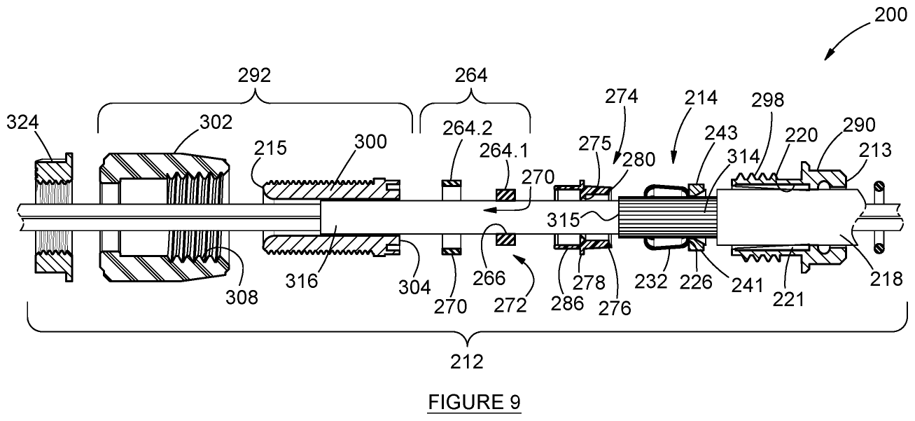

FIG. 9 is a section on line IX in FIG. 6; and

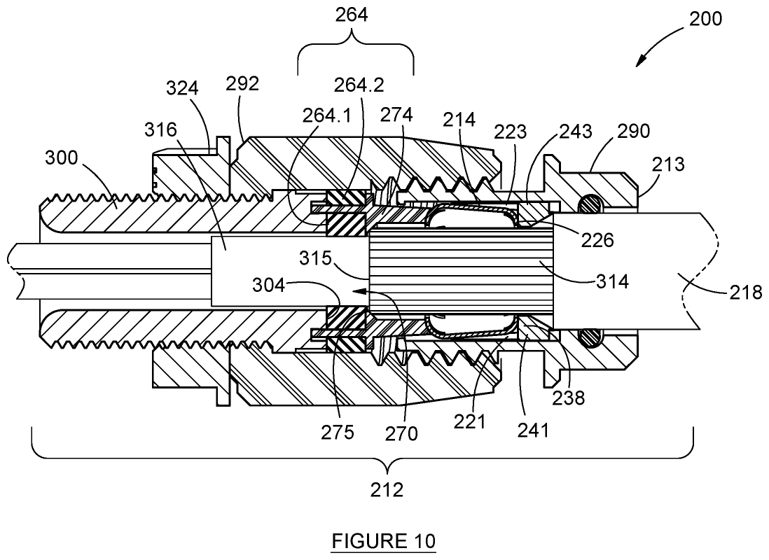

FIG. 10 is an assembled version of FIG. 10.

### DESCRIPTION OF A PREFERRED EMBODIMENT OF THE INVENTION

A first example embodiment of a cable gland is generally designated by the reference numeral 10 in FIGS. 1, 4 and 5.

Referring to FIGS. 1, 4 and 5, the cable gland 10 comprises an elongate body 12 and a cable gripping ferrule 14. The elongate body 12 has a first end 13 and a second end 15 and defines an axial passage 16 extending between the first end 13 and the second end 15 (best shown in FIGS. 4 and 5). The axial passage 16 is configured to receive a cable 18 extending through the body 12. The body 12 comprises a sloping formation 20 (also best shown in FIGS. 4 and 5) adjacent the axially extending passage 16. The cable gripping ferrule 14 forms part of a cable gripping assembly 22.

Referring to FIGS. 2 and 3, the cable gripping ferrule 14 defines a first eye 24 which extends between a cable entry mouth 26 and a cable exit mouth 28 of the cable gripping ferrule 14. The cable gripping ferrule 14 comprises an inner surface 30 adjacent the first eye 24 (best shown in FIG. 3). The cable gripping ferrule 14 comprises a frusta-conical outer surface 32 and cable gripping formations 34 at each of the cable entry mouth 26 and cable exit mouth 28. Referring to FIGS. 1, 4 and 5, the cable gripping ferrule 14 is locatable in the passage 16 and such that the cable entry mouth 26 faces toward the first end 13 of the body 12 and the cable exit mouth 28 faces toward the second end 15 of the body 12. The frusta-conical outer surface 32 is configured such that when the outer surface 32 is urged against the sloping formation 20, the cable gripping ferrule 14, in constrictive manner, directly grips onto the cable 18 with the formations 34 at both the cable entry mouth 26 and the cable exit mouth 28.

The cable entry mouth 26 is substantially circular in shape and has a first diameter d₁. The formations 34 typically comprise teeth or serrations. The cable gripping ferrule 14 comprises a body 35 which defines a preferably linear slit 36 extending between the cable entry mouth 26 and the cable exit mouth 28. The outer surface 32 of the cable gripping ferrule 14 slopes from a first end 37 of the body 35, where the body 35 has a first transverse cross-sectional area to a second end 39 of the body 35 having a second transverse cross-sectional area which is larger than the first transverse cross-sectional area.

The cable gripping assembly 22 optionally comprises and a non-sealing guide ring 38. The guide ring comprises a body 40 defining a second eye 42 extending between a first end 44 and a second end 46 of the body 40. The guide ring 38 comprises a circular inner wall 48 adjacent the second eye 42. The circular inner wall 48 has a second diameter d₂, which is not larger than the first diameter d₁. The guide ring 38 comprises a first part 50 which is funnel shaped. The first part 50 extends between a wider end, located towards the first end 44, and narrower end located intermediate the first end 42 and the second end 44. In use, the guide ring 38 receives and guides the cable 18 (not shown in FIGS. 2 and 3).

Referring to FIGS. 1 to 5, in the first example embodiment, the guide ring 38 is in the form of a first and inner ferrule 38 and the cable gripping ferrule 14 is in the form of a second outer ferrule 14. As best shown in FIGS. 2 and 3, the body 40 of the first and inner ferrule 38 defines a slit 52 extending between the first end 44 and the second end 46. The slit 52 is preferably non-linear to prevent armoured wire strands of the cable 18 (not shown in FIGS. 2 and 3) from entering and becoming wedged in the slit 52. In an alternative embodiment not shown, the slit 52 may be linear and oriented such that armoured wire strands of the cable 18 would not enter the slit 52.

The first ferrule 38 is typically resiliently deformable. In yet another embodiment, the first ferrule 38 may be solid and as such may not define a slot.

As best shown in FIG. 5, the second ferrule 14 is configured such that when the outer surface 32 is urged against the sloping formation 20, the second ferrule 14, grips the cable 18 with the formations 34 and encloses the first and inner ferrule 38 between the inner surface 30 and the cable 18. The second ferrule 14 is resiliently constrictable and is typically made of an electrically conductive material such as copper or aluminium. In an alternative embodiment, the second ferrule 14 may be made of a material which is not electrically conductive.

Referring to FIGS. 1, 4 and 5, the cable gland 10 comprises an annular elastomeric seal 64 locatable in the axially extending passage 16. In the embodiment shown, the seal 64 comprises a first annular elastomeric seal part 64.1 and a second annular elastomeric seal part 64.2 which seal parts are concentric with each other. The first seal part 64.1 comprises an inner sealing surface 66 and an outer wall 67 having a first diameter. The first seal part 64.1 defines a first opening 68 adjacent the inner sealing surface 66 for receiving the cable 18. The second seal part 64.2 comprises an outer sealing surface 70 and an inner wall 71 having a second diameter which is larger than the first diameter. A ring-like opening 72 is defined by the outer wall 67 and the inner wall 71.

Still referring to FIGS. 1, 4 and 5, the cable gland 10 further comprises an annular seal deforming member 74 comprising a body 76 having a first face 78, a second face 80 and an inner wall 82 between the first face 78 and the second face 80. In use, the first face 78 abuts the annular elastomeric seal 64. As best shown in FIG. 4, the inner wall 82 defines an opening 84 for receiving the cable 18. The annular seal deforming member 74 also comprises an axially extending link 86, in the form of a tubular stub, which, in use, extends through the ring-like opening 72.

In other embodiments, the seal 64 may comprise an annular elastomeric seal of unitary construction which presents an inner sealing surface and the outer sealing surface. In such embodiments, the annular elastomeric seal defines a first opening adjacent the inner sealing surface for receiving a cable and at least one further opening between the inner sealing surface and the outer sealing surface. The at least one further opening may comprise a plurality of spaced sockets located on a first circle having a first radius. The first circle located between the inner sealing surface and the outer sealing surface of the annular elastomeric seal. The plurality of spaced sockets may be equi-spaced from one another on the first circle by a first distance.

In the other embodiments referred to above, the axially extending link 86 of the annular seal deforming member 74 may comprise a plurality of prongs which are integrally formed with the first face 78 on a second circle having a second radius. The first circle and second circle may be concentric, and the first radius may be equal to the second radius. The plurality of prongs may be equi-spaced from one another by a second distance which is the same as the first distance.

More detailed descriptions of the annular elastomeric seal of unitary construction and the seal deforming member described above are contained in the applicant's co-pending application with international application number PCT/IB2022/052930, which is incorporated herein by reference.

As best shown in FIGS. 4 and 5, the body 12 of the cable gland 10 comprises a first body part 90 and a second body part 92 which are axially adjacent each other. The first body part 90 and second body part 92 present the first end 13 and second end 15 respectively. The first and second body parts 90, 92 each comprises respective mutually cooperating formations which, when actuated, cause the first and second body parts 90, 92 to be urged towards each other. The first body part 90 defines a first part of the axially extending passage 16 which first part extends from a first end 94 of the first body part 90 to a second end 96 of the first body part 90. A first of the mutually cooperating formations 98 is provided towards the second end 96 of the first body part 90. The first body part 90 is preferably made of an electrically insulating material. The second body part 92 comprises first and second concentric tubular parts 100, 102. The second tubular part 102 has a larger radius than the first tubular part 100. The second tubular part 102 is preferably made of an electrically insulating material. The first tubular part 100 defines a second part of the axially extending passage 16 which second part extends from a first end 104 of the first tubular part 100 to a second end 106 of the first tubular part 100. An external thread 107 is provided towards the second end 106. The first end of 104 the first tubular part 100 provides an abutment surface and the second tubular part 102 comprises a second 108 of said mutually cooperating formations.

In use, and referring to FIGS. 4 and 5 in particular, before being threaded through the cable gland 10, the cable 18 is prepared as follows: first, a region towards an end 110 of the cable 18 is stripped by removing a portion of an outer sheath 112 a first distance from the end 110 to expose a conductive armouring layer 114 beyond a shoulder 115 provided by the outer sheath. Secondly, the conductive armouring layer 114 is removed a second distance, which is less than the first distance, from the end 110 to expose an inner bedding 116. Thirdly, the inner bedding 116 is removed a third distance from the end 110, which is less than the second distance, to expose a bundle of conductors 118.

With the above cable gland 10 in semi-assembled form (that is with the first and second body parts 90, 92 loosely and threadedly connected with each other, the annular elastomeric seal 64, the annular seal deforming member 74 with tubular stub 86 received in the ring-like opening 72 and the second ferrule 14 in position in the axially extending passage 16), the above stripped end region of the cable 18 is sequentially threaded through the first body part 90 (from the first end 94 thereof), the second ferrule 14, the annular seal deforming member 74, the annular elastomeric seal 64 and the second body part 92, (from the first end 104 of the first tubular part 100). The cable 18 is threaded through the cable gland 10 until the shoulder 115 of the outer sheath 112 abuts the first end 40 of the second ferrule 14. The abutment of the shoulder 115 against the formations 34 at the cable entry mouth 26, ensures that the cable 18 stops in a desired position relative to the cable gland 10. In said desired position, the second ferrule 14 is positioned relative to the cable 18 such that the exposed conductive armouring layer 114 extends through the first and second eyes 24, 42 and such that the annular elastomeric seal 64 is positioned relative to the cable 18 such that the exposed inner bedding 116 extends through the opening 70. Once the cable 18 is in the desired position, the threaded first and second mutually cooperating formations 98, 108 are actuated to urge the first and second body parts 90, 92 towards each other. Upon further actuation of the formations 98, 108 the annular elastomeric seal 64 and the annular seal deforming member 74 are sandwiched between the first end 104 of the first tubular part 100 and the wider second end 44 of the second ferrule 14. The second face 80 of the sandwiched seal deforming member 74 urges the second ferrule 14 towards the sloping formation 20 which in turn urges against the outer wall 32 of the second ferrule 14. This serves to compress the second ferrule 14 radially, so that the teeth 34 bite onto the exposed conductive armouring layer 114 and to hold the cable 18 in position relative to the body 12. In use, the first and inner ferrule 38 serves to hold the armouring layer 114 in place, by inhibiting radial displacement of any strands of the armouring layer 114. This ensures that no strand of the armouring layer 114 could become wedged in between the teeth 34 of the second ferrule 14, which would result in a) unreliable electrical contact between the second ferrule 24 and the armouring layer 114 and b) ineffective grip on the cable 18.

Referring to FIG. 5, the annular elastomeric seal 64 is compressed between the first end 104 of the first tubular part 100 and the first face 78 of the seal deforming member 76. This causes the annular elastomeric seal 64 to deform such that the inner sealing surface 66 is urged radially inwardly in sealing engagement with the inner bedding 116 of the cable 18 and the outer sealing surface 70 is urged radially outwardly to seal against an inner sealing surface 117 of the elongate body 12. As the first body part and second body parts 90 and 92, are further urged towards each other, the tubular stub 86 protrudes through the ring-like opening 72 and abuts the first end 104.

In an embodiment where the annular seal deforming member 74 and the second ferrule 14 are made of an electrically conductive material, they serve to provide a conductive train between the conductive armouring layer 114 and the conductive first tubular part 100. Once the first and second body parts 90 and 92 are taut, the second body part 92 is attached to a conductive support wall 122 of an enclosure (not shown), by attaching a conductive threaded nut 124 to the external thread 107 of the conductive first tubular part 100. Once the cable gland 10 is attached to the conductive support wall 122, an electrically conductive path is formed from the conductive armouring layer 114 through the electrically conductive second ferrule 14, the electrically conductive seal deforming member 74, the electrically conductive first tubular part 100 of the second body part 92 and to the conductive support wall 122.

Still referring to FIGS. 1, 4 and 5, a first ancillary seal 126 is located inside the first body part 90 and provides a seal between the first body part 90 and the outer sheath 112 of the cable 18, to stop ingress of fluid which may have entered the passage 16 from the first end 94. A second ancillary seal 128 provides a seal between the first body part 90 and the second body part 92. The second ancillary seal prevents fluid from entering the passage 16 through a space between the mutually cooperation formations 98, 108. A third ancillary seal member 130 provides a seal between the second body part 92 and the conductive support wall 112, to prevent fluid from entering the enclosure (not shown).

Therefore, the cable gland 10 may provide at least two advantages namely that (a) the cable gland 10 may achieve improved pull-out force ratings over the cable glands known in the art; and (b) the cable gland 10 may be easier to assemble onto cables, in particular onto SWA cables, as the cable gland 10 can be in a semi-assembled form when a stripped cable is threaded through the cable gland 10. This reduces the risk of losing parts of the cable gland during assembly of the gland on a cable.

In FIGS. 6, 9 and 10 there is shown a second example embodiment of a cable gland, generally designated by the reference numeral 200. Save for the features discussed below, the cable gland 200 is similar to the first example embodiment shown in FIGS. 1, 4 and 5 and like parts are indicated by like reference numerals.

Referring to FIGS. 6, 9 and 10, the cable gland 200 differs from the first example embodiment in that the non-sealing guide ring 238 is locatable in the body 212 between the first end 213 and the cable entry mouth 226.

Referring to FIGS. 7 and 8, the cable gland 200 further differs from the first embodiment in that the guide ring 238 has a different shape and configuration than the guide ring 238. In particular, the guide ring 238 comprises radially extending formations 241 and 243 which are diametrically opposed to each other. In an alternative embodiment not shown, the body 240 may comprise a single radially extending formation.

As best shown in FIGS. 9 and 10, the cable gland 200 also differs from the first embodiment in that the seal deforming member 274 comprises an inner shoulder formation 275 located on the inner wall 282.

Referring to FIG. 8, the sloping formation 220 defines a first slot 221 and a second slot 223 (not shown in FIG. 9) for receiving the radially extending formations 241 and 243.

Referring to FIG. 10, with the cable gland 200 is in semi-assembled form (that is with the first and second body parts 290, 292 loosely and threadedly connected with each other, the annular seal deforming member 274 with tubular stub 286 received in the ring-like opening 272, the cable gripping ferrule 214 located in the axially extending passage 216 between the seal deforming member 274 and the non-sealing guide ring 238 and with the non-sealing guide ring 238 located in the passage 216 between the first end 213 and the cable entry mouth 226), a stripped end region of the cable 218 is sequentially threaded through the first body part 290 (from the first end 213 thereof), the non-sealing guide ring 238, the cable gripping member 214, the annular seal deforming member 274, the annular elastomeric seal 264 and the second body part 292, (from the first end 304 of the first tubular part 300). The cable 218 is threaded through the cable gland 200 until a shoulder 315 of the armouring layer 314 abuts the shoulder formation 275 of the seal deforming member 274. The abutment of the shoulder 315 against the shoulder formation 275, ensures that the cable 218 stops in a desired position relative to the cable gland 200. In the desired position, the cable gripping ferrule 214 is positioned relative to the cable 218 such that the exposed conductive armouring layer 314 extends through the second eye 242 and the first eye 224 and such that the annular elastomeric seal 264 is positioned relative to the cable 218 such that the exposed inner bedding 316 extends through the opening 270. Once the cable 218 is in the desired position, the threaded first and second mutually cooperating formations 298, 308 are actuated to urge the first and second body parts 290, 292 towards each other. Upon further actuation of the formations 298, 308 the annular elastomeric seal 264 and the annular seal deforming member 274 are sandwiched between the first end 304 of the first tubular part 300 and the wider second end of the cable gripping ferrule 214. The second face 280 of the sandwiched seal deforming member 274 urges the cable gripping ferrule 214 towards the sloping formation 220 which in turn urges against the outer wall 232 of the cable gripping ferrule 214. This serves to compress the cable gripping ferrule 214 radially, so that the teeth 234 at both the cable entry mouth 226 and the cable exit mouth 228 bite onto the exposed conductive armouring layer 314 to hold the cable 218 in position relative to the body 212. In use, the guide ring 238 serves to hold the armouring layer 314 in place, by inhibiting radial displacement of any strands of the armouring layer 314. This ensures that no strand of the armouring layer 314 could become wedged in between the teeth 234 of the second ferrule 214, which would result in a) unreliable electrical contact between the second ferrule 214 and the armouring layer 314 and b) ineffective grip on the cable 218.

In the second embodiment, the funnel shaped first part 250 of the guide ring 238 serves to guide the wires of the armouring layer 314 into place. With the wires of the armouring layer 314 in place, the shoulder 315 will not abut against other parts of the cable gland 200, such as the teeth 34 at the cable entry mouth 226, which may prevent the cable 18 from being properly threaded through the cable gland 200.

The radially extending formations 241 and 243 of the guide ring 238 serve to inhibit rotational displacement of the guide ring 238 relative to the first body part 290. This is particularly important when an artisan threads the cable gland 200 with the cable 218 and at least some of the wires of the armouring layer 314 are bent to face away from the inner bedding 316. In an attempt to position the wires of the armouring layer 314 correctly, the artisan may, when threading the cable gland 200 with the cable 218 and when the shoulder 315 abuts the funnel shaped first part 250, rotate the cable gland 200 about a longitudinal axis (not shown) thereof. Because rotational displacement of the guide ring 238 relative to the first body part is inhibited, the guide ring 238 may be more effective in guiding the wires of the armouring layer 314 into place so that the cable 218 can be threaded through the body 212.

It will be appreciated that there are many variations in detail on the cable gland without departing from the scope and sprit of the appended claims.

For example, in some embodiments where only unarmoured cables are catered for, at least one and even all of the cable gripping assembly, the annular seal deforming member and the first tubular part of the second body part may be made of a dielectric or electrically insulating material.

1. A cable gland (10) comprising:
an elongate body (12) having a first end (13) and a second end (15) and comprising a sloping formation (20) adjacent an axially extending passage (16) extending between the first end (13) and the second end (15) and configured to receive a cable (18) extending through the body (12); and
a cable gripping ferrule (14) locatable in the axially extending passage (16), the cable gripping ferrule (14) defining a first eye (24) extending between a cable entry mouth (26) of the cable gripping ferrule (14) facing the first end (13) of the body (12) and a cable exit mouth (28) of the cable gripping ferrule (14) facing the second end (15) of the body (12), the cable gripping ferrule (14) comprising an inner surface (30) adjacent the first eye (24), a frusta-conical outer surface (32) and cable gripping formations (34) at each of the cable entry mouth (26) and cable exit mouth (28), the frusta-conical outer surface (32) being configured such that when the outer surface (32) is urged against the sloping formation (20), the cable gripping ferrule (14), in constrictive manner, directly grips onto the cable (18) with the formations (34) at both the cable entry mouth (26) and the cable exit mouth (28).

2. The cable gland of claim 1 wherein the cable entry mouth (26) is substantially circular in shape and has a first diameter d1, and wherein the cable gland (10) comprises a non-sealing guide ring (38) for receiving and guiding the cable (18), the guide ring (38) comprising a body (40) defining a second eye (42) and having a circular inner wall (48) adjacent the second eye (42), the circular inner wall (48) having a second diameter d2 which is not larger than the first diameter d1.

3. The cable gland of claim 2 wherein the inner wall (48) of the guide ring (38) extends between a first end (42) of the body (40) and a second end (44) of the body (40) and comprises at least a first part (50) which is funnel shaped and which extends from a wider end thereof located towards the first end (42) to a narrower end thereof located intermediate the first end (42) and the second end (44).

4. The cable gland according to claim 2 wherein the guide ring (38) forms part of an inner ferrule (38), wherein the body (40) defines a slit (52) extending from the first end (44) to the second end (46) and wherein the cable gripping ferrule (14) encloses the inner ferrule (38) between an inner surface (30) and the cable (18).

5. The cable gland according to claim 4 wherein the slit (52) is non-linear.

6. The cable gland according to claim 4 wherein the inner ferrule (38) is resiliently deformable.

7. The cable gland according to claim 1 wherein the guide ring (238) is located in the body (212) between the first end (213) of the body (212) and the cable entry mouth (226) of the cable gripping ferrule (214).

8. The cable gland according to claim 7 wherein the guide ring (238) comprises at least one radially extending formation (231).

9. The cable gland according to claim 1 wherein the cable gripping formations (34) comprise teeth or serrations.

10. The cable gland according to claim 1 wherein the cable gripping ferrule (14) is made of an electrically conductive material.

11. The cable gland according to claim 1 wherein the cable gripping ferrule (14) is resiliently constrictable.

12. The cable gland according to claim 1 wherein the cable gripping ferrule (14) comprises a body (35) which defines a slit (36) extending between the cable entry mouth (26) and the cable exit mouth (28).

13. The cable gland according to claim 12 wherein the outer surface (32) of the cable gripping ferrule (14) slopes from a first end (37) of the body (35) having a first transverse cross-sectional area to a second end (39) of the body (35) having a second transverse cross-sectional area which is larger than the first transverse cross-sectional area.

14. The cable gland according to claim 1 wherein the cable gland comprises an annular elastomeric seal (64) locatable in the axially extending passage (16), the seal (64) comprising an inner sealing surface (66) and an outer sealing surface (70), the seal (64) defining a first opening (68) adjacent the inner sealing surface (66) for receiving the cable (18) and at least one further opening (72) between the inner sealing surface (66) and the outer sealing surface (70).

15. The cable gland according to claim 14 wherein the cable gland comprises an annular seal deforming member (74) comprising a body (76) having a first face (78) which, in use, abuts the annular elastomeric seal (64), a second opposed face (80) and an inner wall (82) between the first face (78) and the second face (80), the inner wall (82) defining an opening (84) for receiving the cable (18).

16. The cable gland according to claim 15 wherein the annular seal deforming member (74) comprises at least one axially extending link (86) which, in use, extends through the at least one further opening (72) and between the first face (80) of the annular seal deforming member (74) and an abutment surface (104) of the cable gland.

17. The cable gland according to claim 1 wherein the body (12) of the cable gland (10) comprises a first body part (90) comprising the first end (13) and a second body part (92) comprising the second end (15) and which are axially adjacent each other, the first and second body parts (92) comprising respective mutually cooperating formations (98, 108) which, when actuated, cause the first and second body parts (90, 92) to be urged towards each other and to cause the outer surface (32) of the cable gripping ferrule (14) to be urged against the sloping formation (20).

18. The cable gland according to claim 17 wherein the first body part (90) defines a first part of the axially extending passage (16) which first part extends from a first end of the first body (90) part to a second end (96) of the first body part (90), a first of the mutually cooperating formations (98) being provided towards the second end (96) of the first body part (90), and the second body part (92) comprising first and second concentric tubular parts (100, 102), the second tubular part (102) having a larger radius than the first tubular part (100), the first tubular part (100) defining a second part of the axially extending passage (16) which second part extends from a first end (122) of the first tubular part to a second end (124) of the first tubular part (100), the first end (122) of the first tubular part (100) providing the abutment surface and the second tubular part (102) comprising a second of said mutually cooperating formations (108).

19. The cable gland according to claim 17 insofar they are dependent on claim 8 wherein the first body part (290) defines at least one slot (221).
